(19) United States
(12) Patent Application Publication
(10) Pub. No.: US 2006/0107296 A1
(43) Pub. Date: May 18, 2006

(54) Remote image tracking and methods thereof

(75) Inventors: Von A. Mock, Boynton Beach, FL (US); Eric T. Eaton, Lake Worth, FL (US); Camilo E. Villamil, Pembroke Pines, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/989,573

(22) Filed: Nov. 16, 2004

(51) Int. Cl. H04N 7/173

(52) U.S. Cl. 725/105

(57) ABSTRACT

An image tracking system (100) includes a plurality of cameras (202-208) in a predetermined area coupled to a communication network, a wireless accessory device (104) programmed to transmit an identification tag to the communication network, a selective call device (250) coupled to the communication network, and a processor (240) coupled to the communication network. The processor (240) is programmed to select at least one of the plurality of cameras when receiving from the communication network the identification tag from the wireless accessory device that has come within a predetermined proximity of the communication network, capture an image within a vicinity of the wireless accessory device from at least one camera, and transmit the image to the selective call device via the communication network.

### FIELD OF THE INVENTION

This invention relates generally to tracking systems, and more particularly to remote image tracking and methods thereof.

### BACKGROUND OF THE INVENTION

There exists several structural forms and methods to detect and capture images of objects including humans and commercial merchandise in commercial enterprises such as area theme parks. Applications of such image capture mechanisms include capturing and storing images of park patrons and later supplying such images to the patrons for purchase.

The existing art, however, falls short of providing a user a device and method for remote image tracking of objects traversing a commercial enterprise. Existing systems using cameras in theme parks fail to track objects and dynamically adjust as needed as the objects traverse the park. These systems are generally static in nature and only provide a picture without further identifying a desired object being tracked.

### SUMMARY OF THE INVENTION

Embodiments in accordance with the invention provide a system and method for remote image tracking of objects traversing a commercial enterprise. There are many commercial and personal applications for such a device. For instance, such a device can be useful in family outings at theme parks where parents would prefer to track their children visually as they move between attractions in the park rather than using intrusive peer communication systems such as walky-talkies. In a similar setting, such a device could also be used by park managers to remotely track images of employees carrying supplies (e.g., soft drinks and/or food) across the park. Of course, embodiments herein can be applied in other scenarios outside parks and should be understood to include factory settings, residential settings and other enterprises.

In a first embodiment of the present invention, an image tracking system includes a plurality of cameras in a predetermined area coupled to a communication network, a wireless accessory device programmed to transmit an identification tag to the communication network, a selective call device coupled to the communication network, and a processor coupled to the communication network. The processor is programmed to select at least one of the plurality of cameras when receiving from the communication network the identification tag from the wireless accessory device that has come within a predetermined proximity of the communication network, capture an image within a vicinity of the wireless accessory device from the at least one camera, and transmit the image to the selective call device via the communication network.

In a second embodiment of the present invention, the aforementioned image tracking system includes a method for tracking an image. The method includes the steps of receiving in the communication system the identification tag transmitted by the wireless accessory device when the wireless accessory device is within a predetermined proximity of the communication network, capturing an image within a vicinity of the wireless accessory device from at least one of the plurality of cameras instructed to capture the image by the processor, and transmitting the image to the selective call device via the communication network.

### BRIEF DESCRIPTION OF THE DRAWINGS

FIG. 1 is an illustration of a system for remotely tracking images of objects traversing a predetermined area in accordance with an embodiment of the present invention.

FIG. 2 is a more detailed view of a system substantially similar to the system of FIG. 1.

FIG. 3 is a flow chart illustrating a method for remote image tracking of objects in a commercial enterprise in accordance with an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

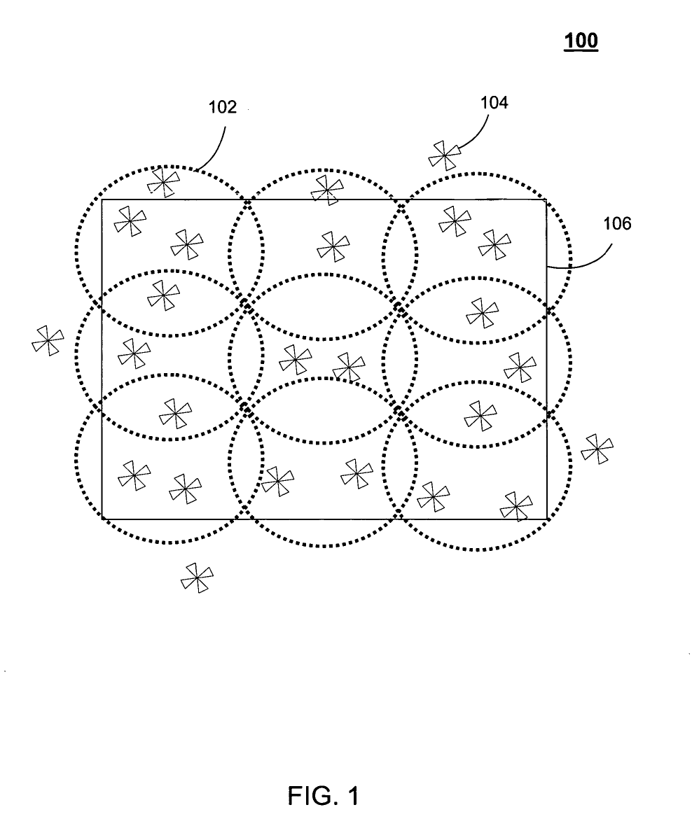

FIG. 1 is an illustration of a system 100 for remotely tracking images of objects carrying a wireless accessory device 104 traversing a predetermined area 106. Such objects are mobile and can take the form of a living being or other article, which carries the wireless accessory device 104 for tracking purposes between communication zones 102. The system 100 is capable of tracking images within a vicinity of a wireless accessory device 104 so long as such device 104 is within the predetermined area 106 defined by the communication zones 102 therein.

The predetermined area comprises any geographical footprint of the system 100, which is defined by the communication network included therein. The predetermined area 106 can represent any public or private sector geographic setting. In the private sector, the predetermined area 106 can represent a commercial enterprise such as a theme park, an industrial setting for manufacturing or transporting goods, or other enterprise setting which can have use for the present invention. In the public sector, the predetermined area 106 can represent a government building (e.g., a courthouse or like setting).

For purposes of illustration only, the invention will be described herein within the settings of a theme park but should not be limited thereto in application to other scenarios. Accordingly, the terms commercial enterprise 106, theme park 106, or park 106 will be used interchangeably as equivalents of the predetermined area 106. It should be understood by one of ordinary skill in the art that embodiments of this invention can be used by any type of commercial enterprise or in any other scenario where tracking by image capture can be useful.

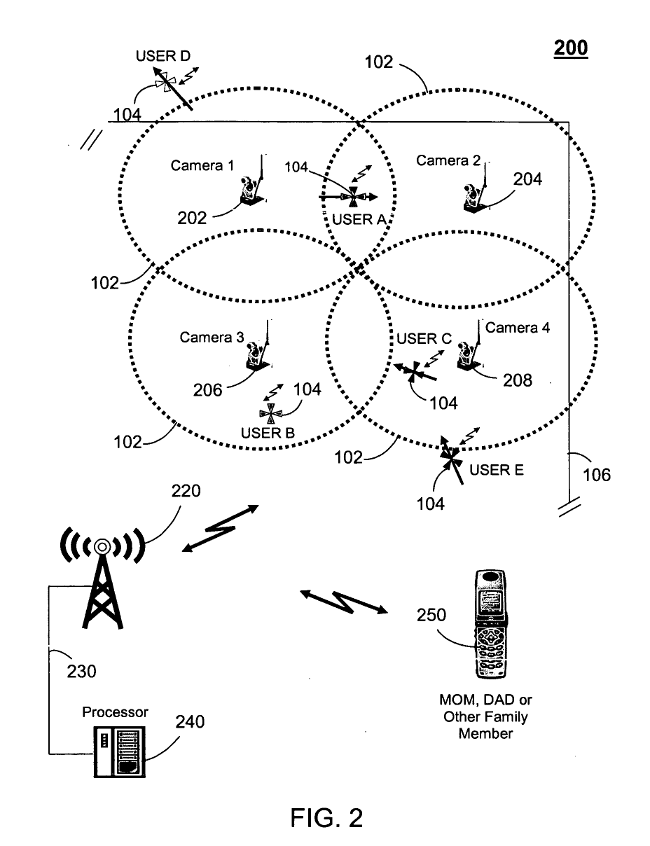

FIG. 2 shows an exploded view 200 of the system 100. The commercial enterprise 106 is shown partially (upper right corner). Similarly, a limited number of communication zones 102 are shown. Each communication zone 102 includes a camera with an integral transceiver for communicating with each of the wireless accessory devices 104. The communication network of the system 100 comprises the plurality of wireless capable cameras 202-208 along with a conventional radio tower 220 and a conventional wire line 230.

The wireless accessory device 104 comprises conventional radio communication technology capable of communicating with the communication network—in this instance, the wireless capable cameras 202-208. Accordingly, the wireless accessory device 104 can take the form of a conventional cell phone, wireless LAN (Local Area Network) device, combinations thereof, or any other radio communication technology suitable for the present invention.

It would be obvious to one of ordinary skill in the art that except for the wireless communication between the wireless accessory devices 104 and the communication network, any combination of wireless, wire line or other means of communication can be used to construct the communication network. For instance, instead of using integral wireless transceivers in each of the cameras 202-208, said transceivers could be co-located as stand-alone units coupled to the camera by conventional wire line.

Thus the communication network illustrated in FIG. 2 can be modified in any manner that maintains connectivity between the elements discussed above such that the resulting structure can achieve an equivalent function, way and result as presented herein.

FIG. 2 further illustrates a processor 240 coupled to communication network and a selective call device 250 (taking the form of a conventional cellular phone in this example). The processor 240 can be any kind of computer system, server, or other apparatus adapted for carrying out the functions described herein. A typical combination of hardware and software could be a general-purpose computer system with a computer program that, when being loaded and executed, controls the computer system such that it carries out the functions described herein.

The processor 240 can be realized in a centralized fashion in one computer system or processor, or in a distributed fashion where different elements are spread across several interconnected computer systems or processors (such as a microprocessor and a DSP). For instance, in a distributed computing environment, it would be obvious to one of ordinary skill in the art that the processing method used by the processor 240 can be distributed by integrating a processing apparatus in each of the plurality of cameras 202-208. The processing method of the invention (described below) would be coordinated between the communication zones 102 to achieve an equivalent function, way and result of the claimed invention.

Like the wireless accessory device 106, the selective call device 250 can be any kind of communication device. For instance, the selective call device 250 can employ radio communications using public or private airwave frequencies, or combinations thereof, and any conventional communication protocol (CDMA: Code Division Multiple Access, GSM: Global System for Mobile communications, 802.11, Bluetooth, FRS: Family Radio Service, etc.). Likewise, the selective call device 250 could also use a wire line 230 for communications.

To associate wireless accessory devices 104 and one or more selective call devices 250, the processor 240 maintains a database of identifications of each device. There are many instances of identification schemes that can be used by the processor 240 for tracking purposes. For example, in a family setting, the selective call device 250 and the wireless accessory device 104 can use the same or similar technology such as a cell phone. These devices are registered in the database, thereby enabling the processor 240 to track the identifications of each device so that any family member can visually and audibly track the other members at the same time, or individually.

Alternatively, the identification tag of each accessory device 104 can represent a selective call address identifying the selective call device 250 which is to receive the images and ambient audio of the locations the wireless accessory device 104 has traversed. This alternative identification scheme has the benefit of minimizing identification management to the selective call devices 250.

It would be obvious to one of ordinary skill in the art that any identification management scheme suitable to the present invention is within the scope and spirit of the claims below.

In a wire line application example, the selective call device 250 might be found at one or more kiosks throughout a theme park 106 that allows a user to visualize tracking of a wireless accessory device 104. To maintain privacy, the kiosk can be programmed to request a login and password so that only a limited set of park patrons can track each other in a theme park 106. Thus, any conventional technology is suitable for the selective call device 250 so long as said technology is capable of communicating with the elements of the system 100.

In one embodiment of the present invention, the processor 240 is programmed to select at least one of the plurality of cameras 202-208 when receiving from the communication network an identification tag from a wireless accessory device 104 that has come within a predetermined proximity of one or more of the communication zones 102 of the communication network described above. The processor 240 is further programmed to capture an image within a vicinity of the wireless accessory device 104 from the at least one camera 202-208, and transmit said image to the selective call device 250 via the communication network illustrated in FIG. 2.

In an alternative embodiment, the plurality of cameras 202-208 are capable of capturing ambient audio. With this capability, the processor 240 is programmed to instruct the at least one camera 202-208 to capture audio, and transmit with the image with the captured audio. This feature helps to enhance the experience of the user of the selective call device 250 who can now visualize images and audio while tracking the wireless accessory device 104 as it traverses the theme park 106.

It should be noted that transmission of the image to the selective call derive 250 can take place at any time and according to any stimulus. For instance, image transmission can take place after a user of the selective call device 250 registers with the processor 240 and requests for a transmission of an image of a particular wireless accessory device 104. Alternatively, the user of the selective call device 250 could request for transmission of the image periodically (e.g., once every half hour). Conversely, park managers of the theme park 106 could program the processor 240 to operate autonomously, thereby transmitting images to the selective call device 250 at any time in any sequence. It should also be noted that the term image(s) includes still and or moving images. Accordingly, all image forms and temporal methods for transmitting the image to the selective call device 250 are intended to be included within the scope of the present invention.

A user of the selective call device 250 is thereby able to visualize a vicinity of a detected wireless accessory device 104. Said vicinity may or may not show in the image a carrier (daughter or son) of the wireless accessory device 104. Even if the image cannot identify or show the carrier of the wireless accessory device 104, the image will provide useful information to the user (mom and or dad) of the selective call device 250 such as, for example, an image that can be used to identify a park attraction within the theme park near to the carrier, density of park patrons within the vicinity of the carrier, or other visual stimulus relevant to the user.

There are several manifestations for detection, or out of range detection of a wireless accessory device 104. The simplest case for detection is where a wireless accessory device 104 is within one or overlapping communication zones 102 (see wireless accessory devices 104 for USERs A, B and C). Each zone 102 covers an area and footprint defined by the conventional transceiver used in each of the cameras 202-208. The transceiver is chosen to cover as much or as little of the predetermined area defined by the theme park 106 as is economically feasible for such enterprises.

A second case for detection is in a fringe (or border) of a communication zone 102 where communication is still feasible (see wireless accessory device 104, USER E). This case can occur when a park patron is in the process of entering or exiting the park 106. Fringe communications can be intermittent depending on location, signal strength of the wireless accessory device 104, environment conditions, and other relevant RF factors.

A third manifestation involves out of range detection of a wireless accessory device 104. This case occurs when the wireless accessory device 104 is outside the radio communication range of all communication zones 102 of the theme park 106 (see wireless accessory device 104, USER D).

A fourth manifestation involves detecting lack of movement of a wireless accessory device 104. Such detection is possible through conventional means of radio triangulation information provided by the communication zones 102 and historical data collected over time of the movements of the wireless accessory device 104. Alternatively, a conventional global positioning receiver can be included in each of the wireless accessory devices 104 to provide the processor 240 location information within the theme park 106.

From these manifestations of detection, a description of several alternative embodiments follow.

By way of triangulation or global positioning information described above, the processor 240 can transmit via the communication network location information to the selective call device 250. This information can be used by the selective call device 250 for any number of applications. For example, a conventional multimedia software application adapted for theme park 106 location services can be programmed into the selective call device 250. This application would be able to pin point graphically on a display of the selective call device 250 the vicinity of the carrier of the wireless accessory device 104. Depending on the sophistication of the aforementioned application, it could also textually identify the park segment, and other relevant park information such as patron density, theme park ride delays, theme park ride the carrier is located at, etc.

In an alternative embodiment, the processor 240 is programmed to transmit to the selective call device 250 via the communication network an event notification if the wireless accessory device 104 is no longer within the predetermined proximity of the communication network (i.e., theme park 106). The event can take the form of an out of range condition as described above. Notice can be provide by way of an audible alarm, visual alarm, tactile alarm or combinations thereof. In addition, notice can include an image of the last location of the wireless accessory device 104. This event is a useful security feature for a parent who wants to know immediately that his or her child has left the theme park 106 grounds with guidance as to where to start looking for the child.

Alternatively, the processor 240 is programmed to transmit to the selective call device 250 an event notification if there is lack of movement of the wireless accessory device 104 for a predetermined amount of time. One of the useful applications of this embodiment is also security. For example, it could provide a means for a parent to detect an insubordinate child who decides to dispose of the wireless accessory device 104 to avoid tracking within the theme park 106.

Since long lines in a theme park setting can result in lack of movement for long periods of time (e.g., 45 minutes), the predetermined time can be set statically or dynamically according to park conditions. To avoid overburdening a user of the selective call device 250 with redundant images, the processor 240 can be programmed to comply with image capture criteria before engaging in the image and audio tracking process described above.

For example, the image capture criteria for directing the processor 240 can be based on park 106 conditions. Such as, for example, if the carrier of the wireless accessory device 104 is detected to be in a region of the park where rides are averaging a delay of 30 minutes, the image capture criteria can direct the processor 240 to set the predetermined time for detecting lack of movement to an interval reflecting such conditions.

Alternatively, image capture criteria can be defined statically and/or dynamically by the user of the selective call device 250 and/or by theme park 106 personnel. In a first embodiment, a user profile is supplied by the selective call device 250 to define the image capture criteria. Alternatively or in combination, a user profile can be supplied by the processor 240 to define the image capture criteria. The user profiles are generated singly or in combination by the users of the selective call device 250 and the processor 240, respectively.

For example, in the case where the selective call device 250 is immobile (e.g., a kiosk as described above), the user of said device can provide a user profile instructing the processor 250 when, how and what images within the vicinity of one or more wireless accessory devices 104 are to be captured and/or transmitted to the selective call device 250. To assist the user of the selective call device 250 and/or a theme park 106 employee in defining one or more user profiles, the processor 240 can supply system options for image processing to these parties.

System options can include but are not limited to:
capturing and transmitting images to the selective call device 250 each time a corresponding wireless accessory device 104 traverses a new communication zone 102—static criteria;
capturing and transmitting an image upon receiving a request from the selective call device 250; otherwise, no images are captured—dynamic criteria;
transmitting images to the selective call device 250 at intervals defined by the user of the selective call device 250—static criteria;
transmitting predefined image types selected by the user of the selective call device 250, e.g., images of a carrier of an accessory device 104 while in the midst of a theme park 106 ride, or while in a crowd—static criteria;
capturing images at all times, but transmitting said images only upon request of the selective call device 250—static and dynamic criteria;
capturing and transmitting images during park 106 events, weather conditions, event notices as defined above, and so on—static criteria.

In a first embodiment, a single user profile is associated with a corresponding one or more wireless accessory devices 104. Alternatively, for each wireless accessory device 104, a unique user profile can be generated by the user of the selective call device 250 or theme park 106 personnel.

Combinations of the embodiments above can be displayed simultaneously on the display of the selective call device 250 for viewing convenience. These images can be, for example, arranged sequentially, tiled or cascaded such that the user of the selective call device 250 can easily select individualized images and/or visualize a succession of events during the course of minutes, hours or otherwise.

It should be evident from these embodiments that there are innumerable options for defining user profiles corresponding to image capture criteria and methods for displaying captured images. The image capture criteria is therefore as expansive as the capability of the image tracking system 100 and the processor 240 coupled thereto. Accordingly, it would be obvious to one of ordinary skill in the art that the image capture criteria can be based on any relevant event or trigger useful to the present invention. Accordingly, such events and/or triggers and methods for display on the selective call device 250 are intended to be within the scope of the claimed invention.

Alternatively, the processor 240 is programmed to transmit to the selective call device 250 routing history of the wireless accessory device 104 as it traverses the theme park 106. The accuracy of this history can depend on the accuracy of locating the wireless accessory device 104. For instance, routing history can be based on mobility between communication zones 102. If the communication zones 102 are small (e.g., based on park segment, or rides) the degree of tracking accuracy will improve. This information would be valuable to the parent who wants to know where the child has been during the course of a day. The resolution of the routing history can be refined further by using conventional triangulation or global positioning techniques as described above.

To more accurately capture an image of the carrier of a wireless accessory device 104, in an alternative embodiment the processor 240 is programmed to adjust at least one among a plurality of camera functions on the at least one camera 202-208 based on location information of the wireless accessory device 104. The plurality of camera functions is selected from the group comprising camera zoom, camera tilt, camera position, camera resolution, and any combination thereof. In an embodiment to further improve accuracy for pin pointing the carrier of a wireless accessory device 104, the processor 240 is programmed to select the at least one camera 202-208 based on location information of the wireless accessory device 104. This information provides the processor 240 a higher level of precision for selecting one or more cameras to pin point the carrier of the wireless accessory device 104.

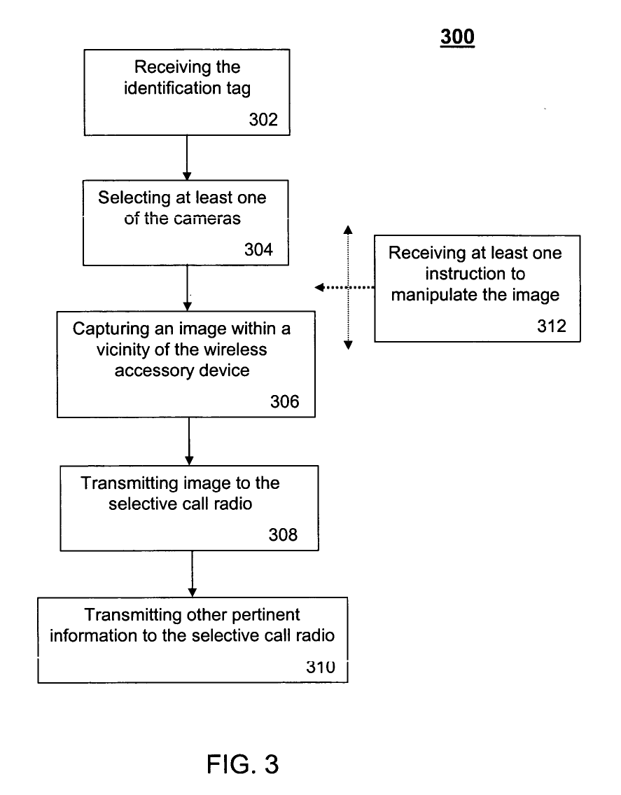

FIG. 3 is a flow chart illustrating a method 300 for remote image tracking of objects in the commercial enterprise 106. The method 300 can be performed in the context of system 100.

In step 302, the processor 240 receives in the communication system the identification tag transmitted by the wireless accessory device 104 when said wireless accessory device 104 is detected within a communication zone 102 of the theme park 106.

In step 304, at least one camera 202-208 is selected. In an alternative embodiment, step 304 further includes the steps of determining location information of the wireless accessory device 104 using triangulation information from communication zones 102 of the communication network, and selecting the at least one camera 202-208 based on the location information. In yet another embodiment of the invention, step 304 further includes the steps of determining location information of the wireless accessory device 104 which includes a global positioning receiver for providing said location information to the processor 240, and selecting the at least one camera 202-208 based on the location information.

In step 306, an image is captured within a vicinity of the wireless accessory device 104 from at least one of the plurality of cameras 202-208 instructed to capture said image by the processor 240. In step 308, the image is transmitted to the selective call device 250 via the communication network.

Further embodiments of the invention are represented by step 310, in which alternative transmitting steps can provide other pertinent information to the selective call device 250. Such information can include location information, event notification when the wireless accessory device 104 is no longer in the theme park 106, event notification if there is lack of movement of the wireless accessory device 104 for a predetermined amount of time, or any combination thereof.

In step 312, at least one instruction can be received by the processor 240 asynchronously (represented by the hashed horizontal and vertical arrows) from the selective call device 250 to manipulate the image being captured by the at least one camera 202-208. Such instruction can include manipulating at least one among a plurality of camera functions on the at least one camera 202-208 based on location information of the wireless accessory device 104. The camera functions can include but are not limited to camera zoom, camera tilt, camera position, camera resolution, and any combination thereof. Further note that the instruction to manipulate can also come from other sources (e.g., the processor 240) other than the selective call device 250 as contemplated by the claims herein.

In light of the foregoing description, it should be recognized that embodiments in the present invention could be realized in hardware, software, or a combination of hardware and software. These embodiments could also be realized in numerous configurations contemplated to be within the scope and spirit of the claims below. It should also be understood that the claims are intended to cover the structures described herein as performing the recited function and not only structural equivalents. The claims are sufficiently general to include equivalent structures.

For example, although a wire line communication system and a wireless communication system may not be structural equivalents in that a wire line employs a physical means (e.g., copper or optical cables) for communication, whereas a wireless communication system employees radio signals with, for example, handoffs between radio towers, in the environment of communications, a wire line communication system and a wireless communication system may be equivalent structures. Accordingly, all equivalent modifications of the description are intended to be included within the scope of this invention as defined in the following claims.

What is claimed is:

1. An image tracking system, comprising:
a plurality of cameras in a predetermined area coupled to a communication network;
a wireless accessory device programmed to transmit an identification tag to the communication network;
a selective call device coupled to the communication network; and
a processor coupled to the communication network, upon complying with image capture criteria, the processor is programmed to:
select at least one of the plurality of cameras when receiving from the communication network the identification tag from the wireless accessory device that has come within a predetermined proximity of the communication network;
capture an image within a vicinity of the wireless accessory device from the at least one camera; and
transmit the image to the selective call device via the communication network.

2. The image tracking system of claim 1, wherein the processor is further programmed to transmit to the selective call device via the communication network location information of the wireless accessory device.

3. The image tracking system of claim 1, wherein the processor is further programmed to transmit to the selective call device via the communication network an event notification if the wireless accessory device is no longer within the predetermined proximity of the communication network.

4. The image tracking system of claim 1, wherein the processor is further programmed to transmit to the selective call device via the communication network an event notification if there is lack of movement of the wireless accessory device for a predetermined amount of time.

5. The image tracking system of claim 1, wherein the processor is further programmed to transmit to the selective call device via the communication network routing history of the wireless accessory device within the predetermined area.

6. The image tracking system of claim 1, wherein the processor is further programmed to adjust at least one among a plurality of camera functions on the at least one camera based on location information of the wireless accessory device.

7. The image tracking system of claim 1, wherein the processor is further programmed to:
capture audio from the at least one camera; and
transmit said audio to the selective call device.

8. The image tracking system of claim 1, wherein the image capture criteria is defined by a user profile supplied by the selective call device.

9. The image tracking system of claim 8, wherein the user profile is associated with the wireless accessory device.

10. The image tracking system of claim 1, wherein the image capture criteria is defined by a user profile supplied by the processor.

11. The image tracking system of claim 10, wherein the user profile is associated with the wireless accessory device.

12. The image tracking system of claim 1, wherein the predetermined area comprises a commercial enterprise, the selective call device includes a display for viewing the image, and the wireless accessory device is carried by a moving object that traverses the commercial enterprise.

13. The image tracking system of claim 1, wherein the communication network comprises communication zones, each communication zone comprising a wireless transceiver coupled to each of the plurality of cameras for communicating with the wireless accessory device.

14. In an image tracking system including a wireless accessory device programmed to transmit an identification tag to a communication network, and wherein the communication network is coupled to a processor, a plurality of cameras in a predetermined area, and a selective call device, a method for remote image tracking, comprising the steps of:
receiving in the communication system the identification tag transmitted by the wireless accessory device when said wireless accessory device is within a predetermined proximity of the communication network;
upon complying with image capture criteria, capturing an image within a vicinity of the wireless accessory device from at least one of the plurality of cameras instructed to capture said image by the processor; and
transmitting the image to the selective call device via the communication network.

15. The method of claim 14, wherein the transmitting step further includes the step of transmitting to the selective call device data from the processor regarding location information of the wireless accessory device.

16. The method of claim 14, wherein the transmitting step further includes the step of transmitting an event notification from the processor to the selective call device if the wireless accessory device is no longer within the predetermined proximity of the communication network.

17. The method of claim 14, wherein the transmitting step further includes the step of transmitting an event notification from the processor to the selective call device if there is lack of movement of the wireless accessory device for a predetermined amount of time.

18. The method of claim 14, further including the step of receiving at least one instruction to manipulate the image being captured by the at least one camera.

19. The method of claim 14, further comprising the step of defining the image capture criteria according to a user profile supplied by the selective call device.

20. The method of claim 14, further comprising the step of defining the image capture criteria according to a user profile supplied by the processor.
